(19) United States
(12) Patent Application Publication
(10) Pub. No.: US 2026/0291648 A1
(43) Pub. Date: Sep. 24, 2026

(54) COMMUNICATION APPARATUS AND INSPECTION METHOD THEREFOR

(71) Applicants: Kabushiki Kaisha Toshiba, Kawasaki-shi (JP); Toshiba Electronic Devices & Storage Corporation, Kawasaki-shi (JP)

(72) Inventor: Hiroo Makari, Yokohama Kanagawa (JP)

(21) Appl. No.: 19/359,119

(22) Filed: Oct. 15, 2025

(30) Foreign Application Priority Data
Mar. 24, 2025 (JP) 2025-048892

(51) Int. Cl. H04L 1/00

(52) U.S. Cl. CPC H04L 1/008; H04L 1/003

(57) ABSTRACT

According to one embodiment, a communication apparatus includes a transmission apparatus and a reception apparatus. The transmission apparatus includes a data generation circuit configured to generate first data, a packet control circuit configured to generate second data based on the first data, an encoder configured to generate third data by encoding the second data, a first storage medium configured to store first reference data having the packet structure, a second storage medium configured to store second reference data not having the packet structure. The reception apparatus includes a conversion circuit configured to convert the serial data into parallel data, a synchronization circuit, a decoder configured to decode the parallel data to generate fourth data, and an inspection circuit configured to detect a bit error.

### CROSS-REFERENCE TO RELATED APPLICATION

This application is based upon and claims the benefit of priority from Japanese Patent Application No. 2025-048892, filed Mar. 24, 2025, the entire contents of which are incorporated herein by reference.

### FIELD

Embodiments described herein relate generally to a communication apparatus and an inspection method therefor.

### BACKGROUND

A communication apparatus using an 8B10B method for converting 8-bit data into a 10-bit code (also referred to as symbol) as a transmission path code of serial communication is known.

### BRIEF DESCRIPTION OF DRAWINGS

FIG. 1 is a block diagram illustrating an example of an overall configuration of a communication apparatus according to a first embodiment.

FIG. 2 is a diagram illustrating a part of a code table of an 8B10B method.

FIG. 3 is a diagram illustrating a code table of K codes of the 8B10B method.

FIG. 4 is a diagram illustrating an example of a configuration of a packet in the 8B10B method in the communication apparatus according to the first embodiment.

FIG. 5 is a diagram illustrating a flowchart of a debugging method in the communication apparatus according to the first embodiment.

FIG. 6 is a diagram illustrating a flowchart of the debugging method in the communication apparatus according to the first embodiment.

FIG. 7 is a diagram illustrating a flowchart of the debugging method in the communication apparatus according to the first embodiment.

FIG. 8 is a block diagram of the communication apparatus according to the first embodiment, illustrating a state of normal communication setting.

FIG. 9 is a block diagram of the communication apparatus according to the first embodiment, illustrating a state of 10B8B decoding error observation setting.

FIG. 10 is a block diagram of the communication apparatus according to the first embodiment, illustrating a state of transmission setting of reference 8B10B data without a packet structure.

FIG. 11 is a block diagram of the communication apparatus according to the first embodiment, illustrating a state of transmission setting of reference 8B10B data with the packet structure in a stop state of a circuit after a 10B8B decoder.

FIG. 12 is a block diagram of the communication apparatus according to the first embodiment, illustrating a state of transmission setting of the reference 8B10B data with the packet structure.

FIG. 13 is a block diagram illustrating an example of an overall configuration of a communication apparatus according to a modification of the first embodiment.

FIG. 14 is a block diagram illustrating an example of an overall configuration of a communication apparatus according to a second embodiment.

FIG. 15 is a diagram illustrating a flowchart of a debugging method in the communication apparatus according to the second embodiment.

FIG. 16 is a diagram illustrating a flowchart of the debugging method in the communication apparatus according to the second embodiment.

FIG. 17 is a block diagram of the communication apparatus according to the second embodiment, illustrating a state of normal communication setting.

FIG. 18 is a block diagram of the communication apparatus according to the second embodiment, illustrating a state of 10B8B decoding error observation setting.

FIG. 19 is a block diagram of the communication apparatus according to the second embodiment, illustrating a state of transmission setting of 8B10B data without a packet structure.

FIG. 20 is a block diagram of the communication apparatus according to the second embodiment, illustrating a state of transmission setting of 8B10B data with the packet structure in a stop state of a circuit after a 10B8B decoder.

FIG. 21 is a block diagram illustrating an example of an overall configuration of a communication apparatus according to a third embodiment.

### DETAILED DESCRIPTION

In general, according to one embodiment, a communication apparatus includes a transmission apparatus configured to output serial data based on an 8B10B method, and a reception apparatus coupled to the transmission apparatus via a transmission path and configured to receive the serial data from the transmission apparatus. The transmission apparatus includes a data generation circuit configured to generate first data, a packet control circuit coupled to the data generation circuit and configured to generate second data having a packet structure based on the first data, an encoder coupled to the packet control circuit and configured to generate third data by encoding the second data into a code having a 10-bit width of the 8B10B method, a first storage medium configured to store first reference data having the packet structure, the first reference data being encoded based on the 8B10B method, a second storage medium configured to store second reference data not having the packet structure and including a packet start code, the second reference data being encoded based on the 8B10B method, a first multiplexer including a first input terminal coupled to the first storage medium, a second input terminal coupled to the second storage medium, and a first output terminal, a second multiplexer including a third input terminal coupled to the encoder, a fourth input terminal coupled to the first output terminal of the first multiplexer, and a second output terminal coupled to the reception apparatus. The reception apparatus includes a conversion circuit configured to convert the serial data into parallel data, a synchronization circuit coupled to the conversion circuit and configured to perform alignment of the parallel data, a decoder coupled to the conversion circuit and configured to decode the parallel data to generate fourth data having an 8-bit width of the 8B10B method, and an inspection circuit coupled to the decoder and configured to detect a bit error based on the fourth data.

Hereinafter, embodiments will be described with reference to the drawings. Note that, in the following description, constituent elements having the same function and configuration are denoted by the same reference signs. Further, in a case where a plurality of constituent elements having a common reference sign is distinguished, the constituent elements are distinguished by adding suffixes to the common reference sign. Note that, in a case where a plurality of constituent elements is not particularly distinguished, only the common reference sign is attached to the plurality of constituent elements, and no suffixes are attached thereto. Here, the suffixes are not limited to subscripts or superscripts, and include, for example, a lower case alphabet added to an end of the reference sign, an index meaning an array, and the like.

### 1. First Embodiment

A communication apparatus according to a first embodiment will be described.

### 1.1 Configuration

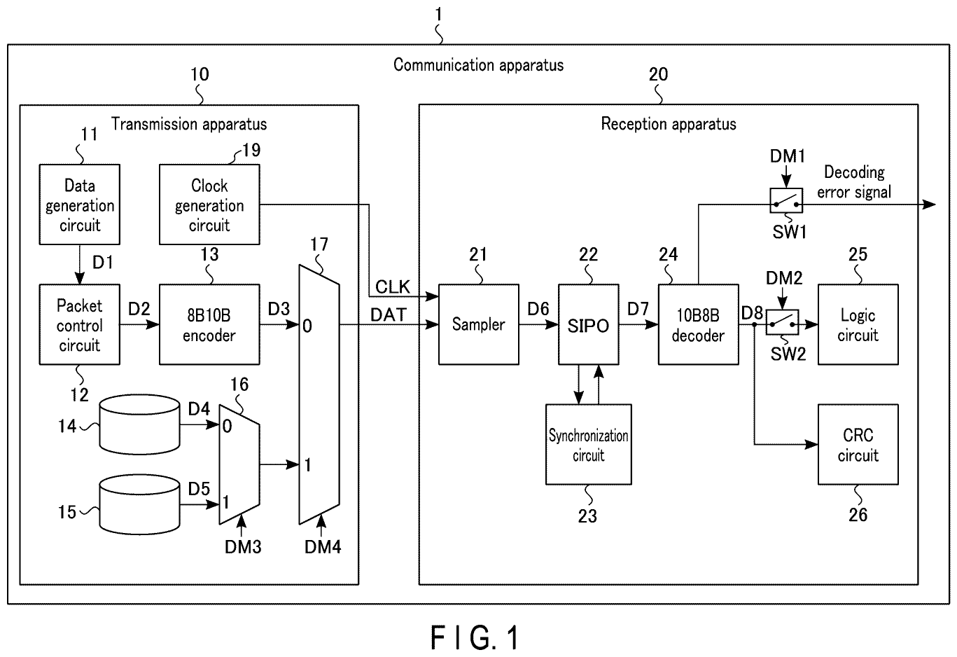

First, an example of a configuration of a communication apparatus 1 will be described with reference to FIG. 1. FIG. 1 is a block diagram illustrating an example of an overall configuration of the communication apparatus 1.

As illustrated in FIG. 1, the communication apparatus 1 includes a transmission apparatus 10 and a reception apparatus 20. The transmission apparatus 10 and the reception apparatus 20 are coupled via a transmission path.

The transmission apparatus 10 generates a packet of transmission data using an 8B10B method. The transmission apparatus 10 transmits serial data DAT and a clock signal CLK to the reception apparatus 20 via the transmission path. The clock signal CLK is used in a case where the reception apparatus 20 samples the serial data DAT.

The 8B10B method is one of serial communication methods. The 8B10B method is a method of converting 8-bit data into a 10-bit code (also referred to as symbol) and transmitting the code. In the 8B10B method, a 10-bit code whose run length is limited so that the difference between the number of “1” bits and the number of “0” bits is always within ±1 and the “1” bits and the “0” bits are not continuous for 5 bits or more is used. In addition, in the 8B10B method, in a case where the 8-bit data is converted into the 10-bit code, the 10-bit code to be converted is different depending on the difference between the number of “1” bits and the number of “0” bits of the previously converted code (symbol). Details of the 10-bit code will be described below.

The transmission apparatus 10 includes a data generation circuit 11, a packet control circuit 12, an 8B10B encoder 13, data storage media (storage devices) 14 and 15, multiplexers 16 and 17, and a clock generation circuit 19.

The data generation circuit 11 generates data D1 to be transmitted to the reception apparatus 20. More specifically, the data generation circuit 11 generates, for example, the data D1 (also referred to as a payload) of a plurality of cycles having an 8-bit width (unit). The data D1 is 8-bit width data having no packet structure to be described below. The data generation circuit 11 is coupled to the packet control circuit 12. The data generation circuit 11 transmits the data D1 to the packet control circuit 12.

The packet control circuit 12 executes control for generating the 8-bit width packet based on the data D1 received from the data generation circuit 11. More specifically, for example, the packet control circuit 12 adds a start code indicating a start position of the packet (for example, K28.5 that is one of K codes of the 8B10B method), a cyclic redundancy check (CRC) code generated from the data D1, an end code indicating an end position of the packet (for example, K29.7 that is one of the K codes of the 8B10B method), and the like to the data D1 (payload) to generate the 8-bit width packet. Details of the structure of the packet will be described below. The CRC code is used to detect a bit error in the packet. A method other than the CRC may be used to detect the bit error. The packet control circuit 12 is coupled to the 8B10B encoder 13. The packet control circuit 12 transmits data D2 with an 8-bit width packet structure to the 8B10B encoder 13.

The 8B10B encoder 13 encodes the 8-bit data into the 10-bit code. Hereinafter, the encoded data is also referred to as 8B10B data. The 8B10B encoder 13 encodes the data D2 received from the packet control circuit 12 to generate 10-bit width data D3. That is, the 8B10B encoder 13 generates the 8B10B data with a packet structure. The 8B10B encoder 13 is coupled to a first input terminal of the multiplexer 17. The 8B10B encoder 13 transmits the data D3 (8B10B data D3 with the packet structure) to the multiplexer 17.

The data storage medium 14 stores data D4 used for inspection (debugging) of the communication apparatus 1. The data D4 is reference data configured by a 10-bit width code corresponding to the 8B10B method. The data D4 has the packet structure similarly to the data D3 generated by the 8B10B encoder 13. Hereinafter, the data D4 is also referred to as reference 8B10B data D4 with the packet structure. The data storage medium 14 is coupled to a first input terminal of the multiplexer 16. The data storage medium 14 transmits the reference 8B10B data D4 with the packet structure to the multiplexer 16.

The data storage medium 15 stores data D5 used for debugging of the communication apparatus 1. The data D5 is reference data configured by a 10-bit width code corresponding to the 8B10B method. The data D5 does not have the packet structure. That is, the data D5 does not include the CRC code, the packet end code, and the like. However, it is necessary to include the packet start code (for example, K28.5) necessary for 10-bit alignment. Hereinafter, the data D5 is also referred to as reference 8B10B data D5 without the packet structure and including the start code. The data storage medium 15 is coupled to a second input terminal of the multiplexer 16. The data storage medium 15 transmits the reference 8B10B data D5 without the packet structure and including the start code to the multiplexer 16.

The multiplexer 16 includes the first input terminal, the second input terminal, and an output terminal. The first input terminal is coupled to the data storage medium 14, and the second input terminal is coupled to the data storage medium 15. The output terminal is coupled to a second input terminal of the multiplexer 17. A debug mode signal DM3 is input to the multiplexer 16. For example, in a case where the debug mode signal DM3 is “0” data, the first input terminal and the output terminal are coupled, and in a case where the debug mode signal DM3 is “1” data, the second input terminal and the output terminal are coupled. That is, in the case where the debug mode signal DM3 is “0” data, the multiplexer 16 can transmit the data D4 (reference 8B10B data D4 with the packet structure) to the multiplexer 17. Further, in the case where the debug mode signal DM3 is “1” data, the multiplexer 16 can transmit the data D5 (reference 8B10B data D5 without the packet structure and including the start code) to the multiplexer 17.

The multiplexer 17 includes the first input terminal, the second input terminal, and a data output terminal. The first input terminal is coupled to the 8B10B encoder 13, and the second input terminal is coupled to the multiplexer 16. The data output terminal is coupled to a sampler 21 of the reception apparatus 20 via the transmission path (communication path). A debug mode signal DM4 is input to the multiplexer 17. For example, in a case where the debug mode signal DM4 is “0” data, the first input terminal and the data output terminal are coupled, and in a case where the debug mode signal DM4 is “1” data, the second input terminal and the data output terminal are coupled. That is, in the case where the debug mode signal DM4 is “0” data, the multiplexer 17 can transmit the data D3 as the serial data DAT to the sampler 21. Further, in the case where the debug mode signal DM4 is “1” data, the multiplexer 17 can transmit the data D4 or the data D5 as the serial data DAT to the sampler 21.

The clock generation circuit 19 generates the clock signal CLK that is used in a case where the sampler 21 of the reception apparatus 20 samples reception data. The clock generation circuit 19 transmits the clock signal CLK to the sampler 21.

The reception apparatus 20 receives the serial data DAT and the clock signal CLK from the transmission apparatus 10. The reception apparatus 20 includes the sampler 21, a serial-in parallel-out (SIPO) conversion circuit 22, a synchronization circuit 23, a 10B8B decoder 24, a logic circuit 25, a CRC circuit 26, and switch circuits SW1 and SW2.

The sampler 21 is a reception circuit that samples the serial data DAT based on the clock signal CLK. The sampler 21 is coupled to the SIPO 22. The sampler 21 transmits serial data D6 sampled based on the clock signal CLK to the SIPO 22.

The SIPO 22 is a shift register that converts the serial data D6 into 10-bit parallel data D7 under the control of the synchronization circuit 23. The SIPO 22 is coupled to the synchronization circuit 23 and the 10B8B decoder 24. The SIPO 22 transmits the parallel data D7 to the 10B8B decoder 24.

The synchronization circuit 23 aligns the parallel data D7. More specifically, for example, the synchronization circuit 23 synchronizes a 10-bit width boundary with the 10-bit code of the 8B10B method based on the start code (for example, the K28.5 code) of the packet included in the serial data D6.

The 10B8B decoder 24 decodes a 10-bit code into 8-bit data. More specifically, the 10B8B decoder 24 decodes the 10-bit width parallel data D7 to generate 8-bit width data D8. Furthermore, the 10B8B decoder 24 checks the decoded data D8. The 10B8B decoder 24 can output a decoding error signal in a case where a decoding result does not conform to a rule of the 8B10B method. For example, in a case where the received 10-bit code is not in a code table of the 8B10B method or in a case where a sign of running disparity to be described below is different, the 10B8B decoder 24 determines that the decoding result is a 10B8B decoding error. For example, in a case where the 10B8B decoding error occurs, the 10B8B decoder 24 sets the data D8 to all “0”. The 10B8B decoder 24 is coupled to one terminal of the switch circuit SW1, one terminal of the switch circuit SW2, and the CRC circuit 26. The 10B8B decoder 24 outputs the decoding error signal to an outside via the switch circuit SW1. The decoding error signal is used, for example, at the time of debugging. The 10B8B decoder 24 transmits the data D8 to the logic circuit 25 via the switch circuit SW2. In addition, the 10B8B decoder 24 transmits the data D8 to the CRC circuit 26.

The logic circuit 25 executes logic control based on the data D8. The logic control is optional.

The CRC circuit 26 executes CRC check to inspect the presence or absence of a bit error. Specifically, the CRC circuit 26 inspect the presence or absence of a bit error by executing CRC calculation for a payload portion of the packet, and comparing the calculation result with the CRC bit added to the packet. For example, in a case where the bit error is detected, the CRC circuit 26 may notify the logic circuit 25 not to use the data of the packet. For example, the transmission apparatus 10 retransmits the data of the packet in which the bit error is detected to the reception apparatus 20 based on the result of the CRC.

The switch circuit SW1 switches coupling between the 10B8B decoder 24 and the outside. One end of the switch circuit SW1 is coupled to the 10B8B decoder 24, and the other end of the switch circuit SW1 is coupled to an external output terminal of the reception apparatus 20 (not illustrated). The debug mode signal DM1 is input to the switch circuit SW1 as a control signal. For example, in a case where the debug mode signal DM1 is “0” data, the switch circuit SW1 is turned off. On the other hand, in a case where the debug mode signal DM1 is “1” data, the switch circuit SW1 is turned on.

The switch circuit SW2 switches coupling between the 10B8B decoder 24 and the logic circuit 25. One end of the switch circuit SW2 is coupled to the 10B8B decoder 24, and the other end of the switch circuit SW2 is coupled to the logic circuit 25. A debug mode signal DM2 is input to the switch circuit SW2 as a control signal. For example, in a case where the debug mode signal DM2 is “0” data, the switch circuit SW1 is turned on. Further, in a case where the debug mode signal DM2 is “1” data, the switch circuit SW2 is turned off.

### 1.2 Code Table of 8B10B Method

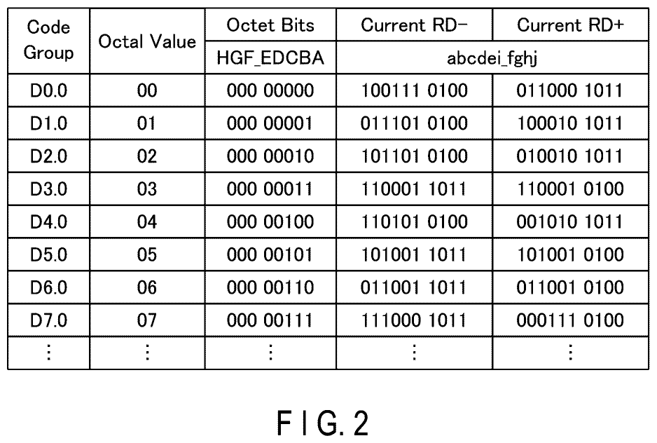

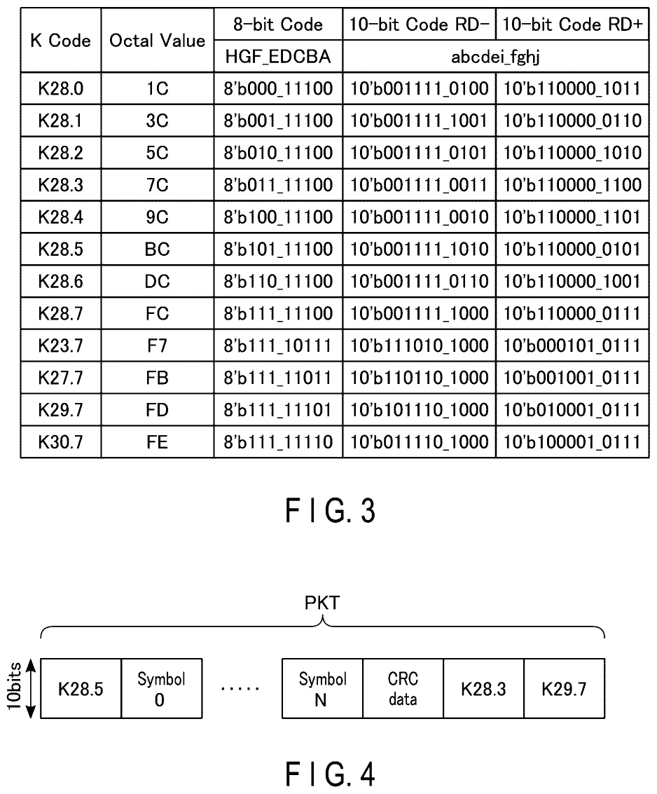

Next, the code table of the 8B10B method will be described with reference to FIGS. 2 and 3. FIG. 2 is a diagram illustrating a part of the code table of the 8B10B method. FIG. 3 is a diagram illustrating the code table of the K codes of the 8B10B method.

As illustrated in FIG. 2, an octal value, 8-bit data, a 10-bit code (RD−), and a 10-bit code (RD+) are illustrated for each of code groups D0.0 to D7.0. Note that the actual data code table includes data codes D0.0 to D31.7. There are two types of codes after 10-bit conversion, namely, a case where running disparity (RD) is minus (RD−) and a case where the running disparity is plus (RD+). Therefore, the type of the data code is 256 (types of the 8-bit data)×2=512 types.

In the case where the running disparity is minus (RD−), the number of “0” bits and the number of “1” bits in the code are the same or the number of “1” bits is larger. Further, in the case where the running disparity is plus (RD+), the number of “0” bits and the number of “1” bits in the code are the same or the number of “0” bits is larger.

For example, an initial value of the running disparity is minus (RD−). The 8B10B encoder 13 does not change the running disparity (RD) in a case where the number of “0” bits and the number of “1” bits of the previously converted code (symbol) are the same. The 8B10B encoder 13 selects the plus (RD+) code in the next conversion in a case where the running disparity of the previously converted code is minus (RD−) and the number of “1” bits is larger than the number of “0” bits. Furthermore, the 8B10B encoder 13 selects the minus (RD−) code in the next conversion in a case where the running disparity of the previously converted code is plus (RD+) and the number of “0” bits is larger than the number of “1” bits. For example, in a case where the 10-bit code does not conform to the above rule, the 10B8B decoder 24 outputs the decoding error signal.

As illustrated in FIG. 3, in the 8B10B method, a plurality of K codes is provided as control codes. For example, in a case where a packet is generated, a K code is added to the data code described with reference to FIG. 2. For example, K28.5 is the start code of the packet. The K29.7 code is the end code of the packet. The K28.3 code is an idle code. For example, in a case where there is a blank portion for a fixed-length packet or in a case where there is an interval between packets, the portion is filled with the K28.3 code.

### 1.3 Configuration of Packet

Next, an example of a configuration of a packet PKT in the 8B10B method will be described with reference to FIG. 4. FIG. 4 is a diagram illustrating an example of a configuration of the packet PKT in the 8B10B method. Note that the example illustrated in FIG. 4 illustrates the packet PKT encoded in the 10-bit code, but the packet PKT of 8-bit data has a similar configuration.

As illustrated in FIG. 4, the packet PKT includes the K28.5 code, the plurality of symbols (data codes), the CRC code, the K28.3 code, and the K29.7 code.

The K28.5 code is arranged in a head of the packet PKT. The plurality of symbols (codes) corresponding to the payload is arranged next to the K28.5 code. In the example illustrated in FIG. 4, N+1 (N is an integer of 0 or more) symbols 0 to N are provided. Any one of the data codes described with reference to FIG. 2 is allocated to each symbol. The CRC code is arranged next to the plurality of symbols. The K28.3 code is arranged next to the CRC code, for example. Note that the K28.3 code is arranged in a case where a free space occurs in the fixed-length packet PKT. Therefore, the packet PKT may not include the K28.3 code. The K29.7 code is arranged at the end of the packet PKT.

### 1.4 Debugging Method

Next, a debugging method (inspection method) for the communication apparatus 1 will be described. For example, in the communication apparatus 1, in a case where a problem occurs in quality of the transmission path (a cable, contact of a connector, a substrate, or the like), a power supply (external noise, voltage drop, or the like), communication restriction (interval of packets, disturbance in timing of the control signal in the packet control, disturbance in the packet structure), a system, or the like, a reception error occurs in the reception apparatus 20. Hereinafter, a debugging method in a case of identifying and inspecting these problems will be described.

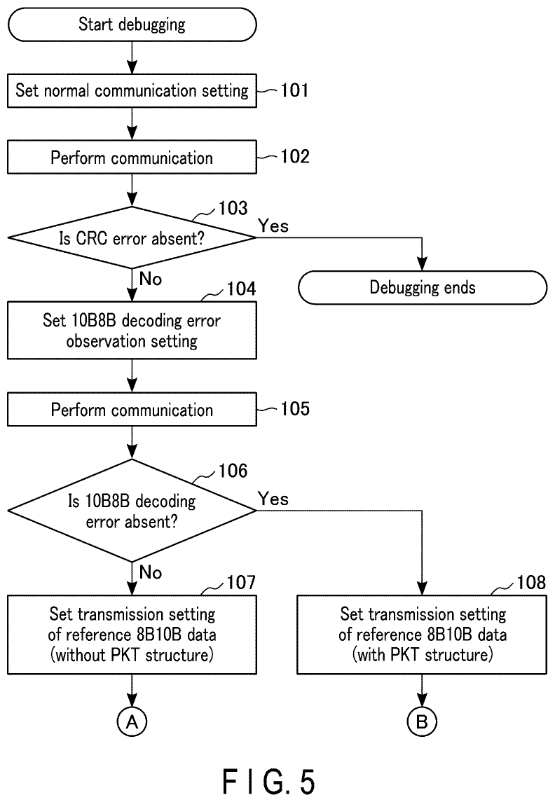

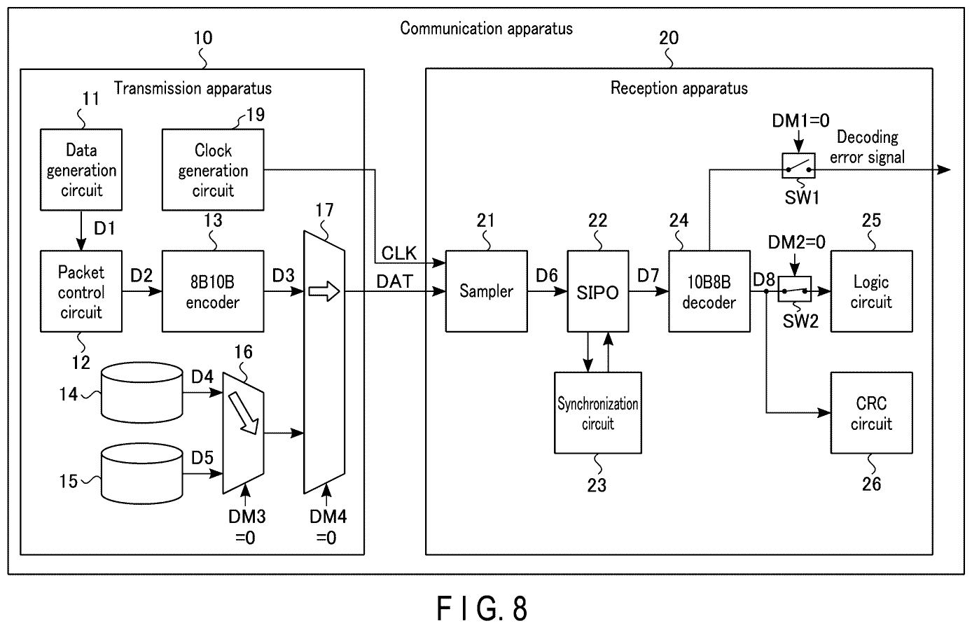

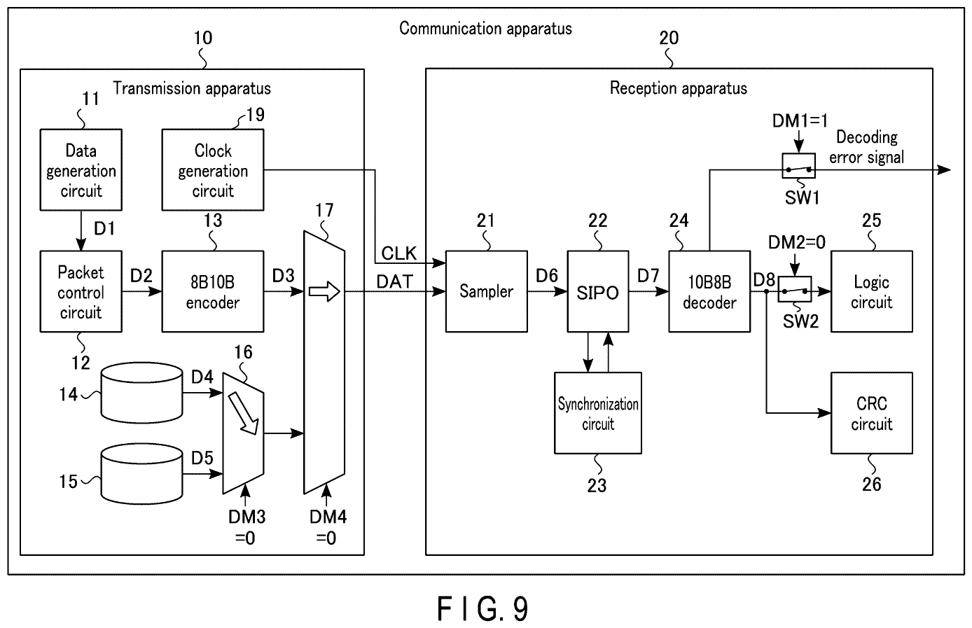

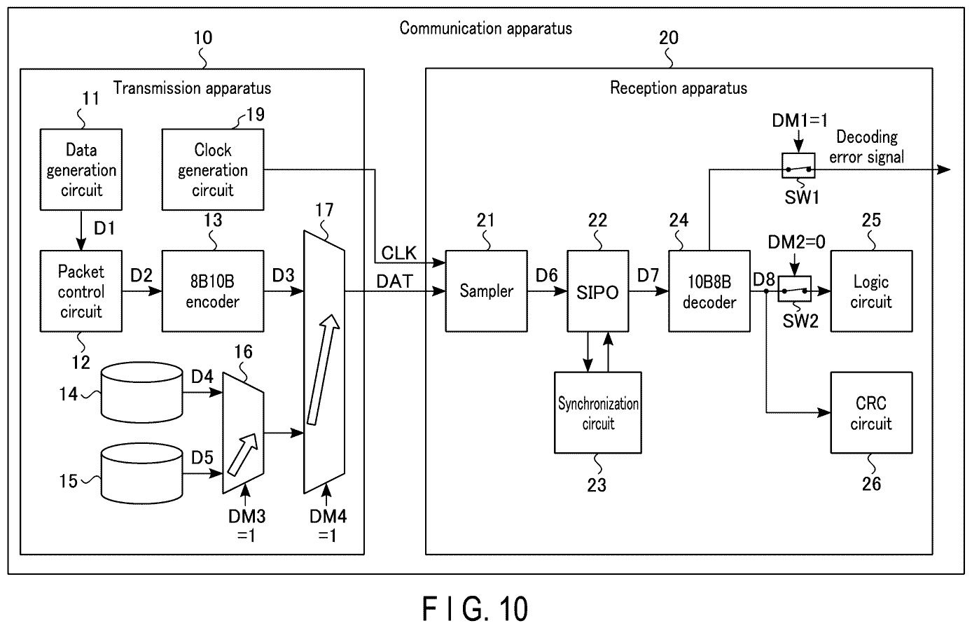

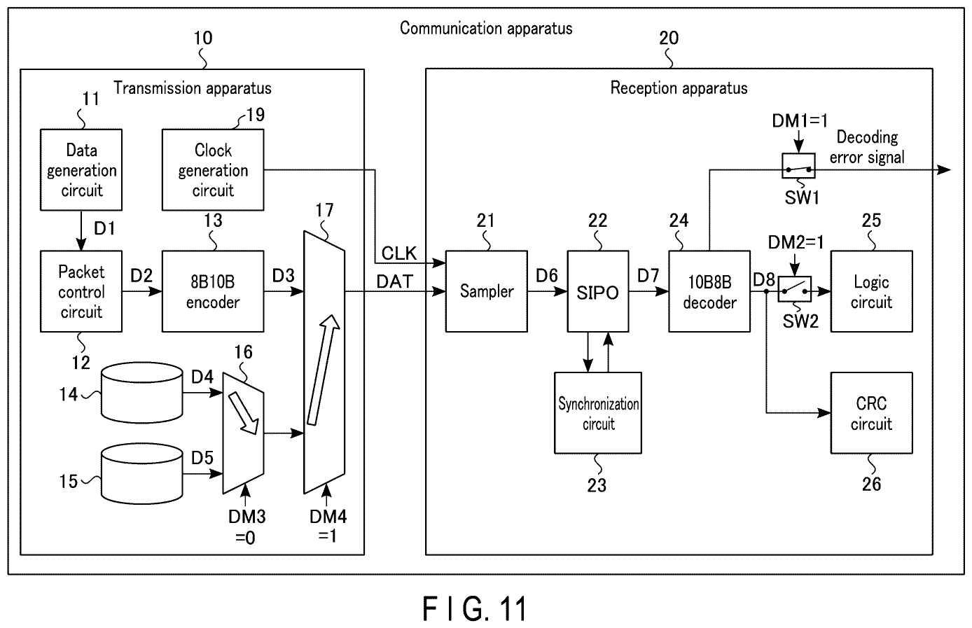

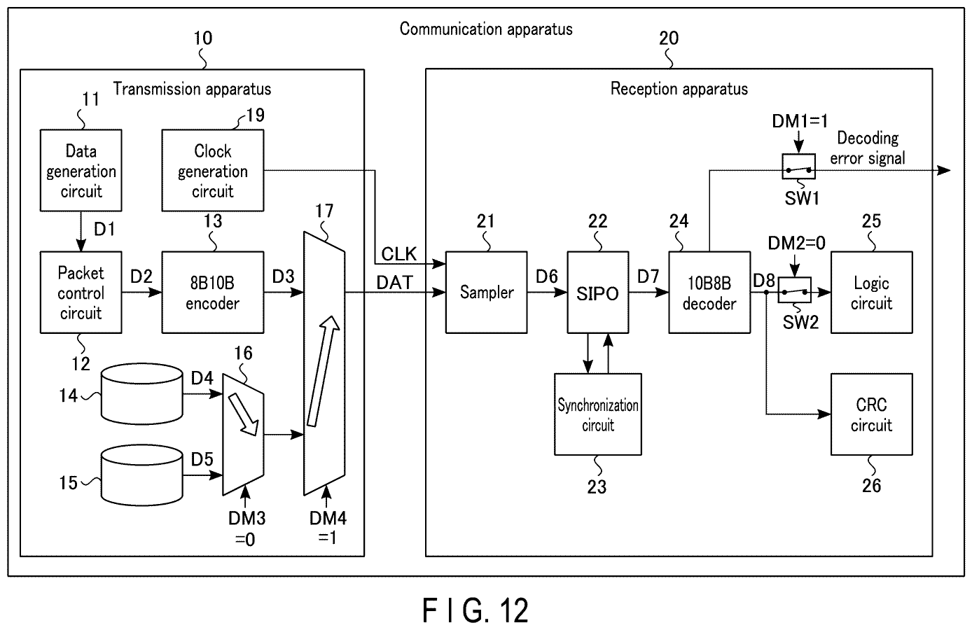

FIGS. 5 to 7 are diagrams illustrating flowcharts of the debugging method. FIG. 8 is a block diagram of the communication apparatus 1 illustrating a state of normal communication setting. FIG. 9 is a block diagram of the communication apparatus 1 illustrating a state of 10B8B decoding error observation setting. FIG. 10 is a block diagram of the communication apparatus 1 illustrating a state of transmission setting of the reference 8B10B data without the packet structure and including the start code. FIG. 11 is a block diagram of the communication apparatus 1, illustrating a state of transmission setting of the reference 8B10B data with the packet structure in a stop state of a circuit after the 10B8B decoder 24. FIG. 12 is a block diagram of the communication apparatus, illustrating a state of transmission setting of the reference 8B10B data with the packet structure.

As illustrated in FIG. 5, debugging of the communication apparatus 1 is started. First, the communication apparatus 1 is set to the normal communication setting (S101). The normal communication setting is setting in a case where data is transmitted from the transmission apparatus 10 to the reception apparatus 20 in normal operation. As illustrated in FIG. 8, the debug mode signals DM1, DM2, DM3, and DM4 are set to “0”. In the transmission apparatus 10, the multiplexer 16 electrically couples the first input terminal and the output terminal. The multiplexer 17 electrically couples the first input terminal and the data output terminal. As a result, the transmission apparatus 10 can transmit the data D3 (8B10B data D3 with the packet structure) output from the 8B10B encoder 13 as the serial data DAT to the reception apparatus 20 (sampler 21). In the reception apparatus 20, the switch circuit SW1 is turned off. As a result, the decoding error signal output from the 10B8B decoder 24 is not output to the outside. In addition, the switch circuit SW2 is turned on. As a result, the 10B8B decoder 24 can transmit the data D8 to the logic circuit 25.

As illustrated in FIG. 5, next, the transmission apparatus 10 performs communication of the data D3 (8B10B data D3 with the packet structure) generated by the 8B10B encoder 13 (S102). In this case, the data D3 based on the data D1 output from the data generation circuit 11 is transmitted to the reception apparatus 20. The CRC circuit 26 performs CRC check of the reception data and checks the presence or absence of a bit error.

In a case where a CRC error is absent (S103_Yes), that is, in a case where the bit error is absent, the debugging of the communication apparatus 1 is terminated.

In a case where the CRC error is not absent (present) (S103_No), the communication apparatus 1 is set to the 10B8B decoding error observation setting (S104). The 10B8B decoding error observation setting is setting for observing the presence or absence of an occurrence of the 10B8B decoding error in the 10B8B decoder 24. As illustrated in FIG. 9, the debug mode signal DM1 is set to “1”, and the debug mode signals DM2, DM3, and DM4 are set to “0”. In the transmission apparatus 10, the multiplexer 16 electrically couples the first input terminal and the output terminal. The multiplexer 17 electrically couples the first input terminal and the data output terminal. As a result, as in the normal communication setting, the transmission apparatus 10 can transmit the data D3 (8B10B data D3 with the packet structure) output from the 8B10B encoder 13 as the serial data DAT to the reception apparatus 20 (sampler 21). In the reception apparatus 20, the switch circuit SW1 is turned on. As a result, the decoding error signal output from the 10B8B decoder 24 can be output to the outside. In addition, the switch circuit SW2 is turned on. As a result, the 10B8B decoder 24 can transmit the data D8 to the logic circuit 25.

As illustrated in FIG. 5, next, the transmission apparatus 10 performs communication of the data D3 generated by the 8B10B encoder 13 (S105). The presence or absence of the 10B8B decoding error is checked by observing the decoding error signal output from the 10B8B decoder 24.

In a case where the 10B8B decoding error is not absent (S106_No), the communication apparatus 1 is set to transmission setting of the reference 8B10B data without the packet structure and including the start code (S107). As illustrated in FIG. 10, the debug mode signals DM1, DM3, and DM4 are set to “1”, and the debug mode signal DM2 is set to “0”. In the transmission apparatus 10, the multiplexer 16 electrically couples the second input terminal and the output terminal. The multiplexer 17 electrically couples the second input terminal and the data output terminal. As a result, the transmission apparatus 10 can transmit the data D5 (reference 8B10B data D5 without the packet structure and including the start code) in the data storage medium 15 as the serial data DAT to the reception apparatus 20 (sampler 21). In the reception apparatus 20, the switch circuit SW1 is turned on. As a result, the decoding error signal output from the 10B8B decoder 24 can be output to the outside. In addition, the switch circuit SW2 is turned on. As a result, the 10B8B decoder 24 can transmit the data D8 to the logic circuit 25.

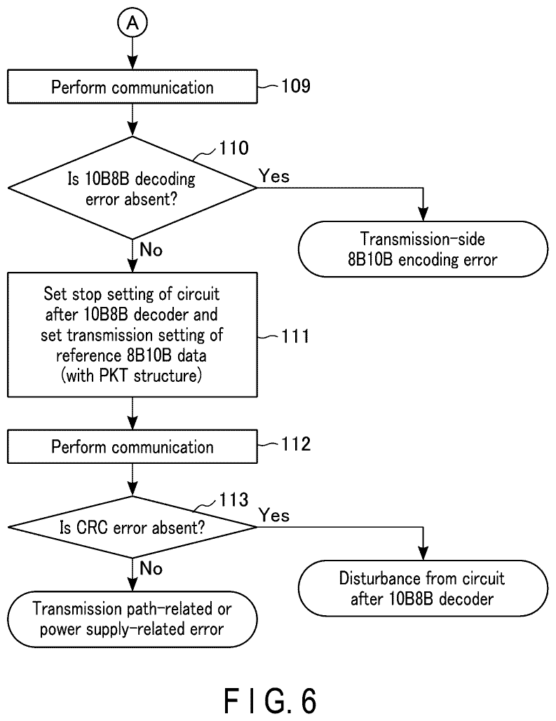

As illustrated in FIG. 6, next, the transmission apparatus 10 performs communication of the reference 8B10B data D5 without the packet structure and including the start code stored in the data storage medium 15 (S109). The presence or absence of the 10B8B decoding error is checked by observing the decoding error signal output from the 10B8B decoder 24.

In a case where the 10B8B decoding error is absent (S110_Yes), there is a high possibility that an error has occurred in the 8B10B encoder 13 on the transmission apparatus 10 side.

In a case where the 10B8B decoding error is not absent (S110_No), the communication apparatus 1 is set to transmission setting of the reference 8B10B data with the packet structure in the stop state of the circuit after the 10B8B decoder 24 (S111). The circuit after the 10B8B decoder 24 is a circuit (excluding the CRC circuit 26) that executes processing using the data D8 output from the 10B8B decoder 24, and in the present embodiment, the logic circuit 25 corresponds thereto. As illustrated in FIG. 11, the debug mode signals DM1, DM2, and DM4 are set to “1”, and the debug mode signal DM3 is set to “0”. In the transmission apparatus 10, the multiplexer 16 electrically couples the first input terminal and the output terminal. The multiplexer 17 electrically couples the second input terminal and the data output terminal. As a result, the transmission apparatus 10 can transmit the data D4 (reference 8B10B data D4 with the packet structure) in the data storage medium 14 as the serial data DAT to the reception apparatus 20 (sampler 21). In the reception apparatus 20, the switch circuit SW1 is turned on. As a result, the decoding error signal output from the 10B8B decoder 24 can be output to the outside. In addition, the switch circuit SW2 is turned off. As a result, the 10B8B decoder 24 does not transmit the data D8 to the logic circuit 25. That is, the downstream-side circuit from the 10B8B decoder 24 is in the stop state.

As illustrated in FIG. 6, next, the transmission apparatus 10 performs communication of the reference 8B10B data D4 with the packet structure stored in the data storage medium 14 (S112). The CRC circuit 26 performs CRC of the reception data and checks the presence or absence of a bit error.

In a case where the CRC error is absent (S113_Yes), there is a high possibility that an error has occurred due to disturbance from the downstream-side circuit from the 10B8B decoder 24.

In a case where the CRC error is not absent (S113_No), there is a high possibility that an error has occurred related to the transmission path or the power supply.

As illustrated in FIG. 5, in a case where the 10B8B decoding error is absent in step S106 (S106_Yes), the communication apparatus 1 is set to the transmission setting of the reference 8B10B data with the packet structure (S108). As illustrated in FIG. 12, the debug mode signals DM1 and DM4 are set to “1”, and the debug mode signals DM2 and DM3 are set to “0”. In the transmission apparatus 10, the multiplexer 16 electrically couples the first input terminal and the output terminal. The multiplexer 17 electrically couples the second input terminal and the data output terminal. As a result, the transmission apparatus 10 can transmit the data D4 (reference 8B10B data D4 with the packet structure) in the data storage medium 14 as the serial data DAT to the reception apparatus 20 (sampler 21). In the reception apparatus 20, the switch circuit SW1 is turned on. As a result, the decoding error signal output from the 10B8B decoder 24 is output to the outside. In addition, the switch circuit SW2 is turned on. As a result, the 10B8B decoder 24 can transmit the data D8 to the logic circuit 25.

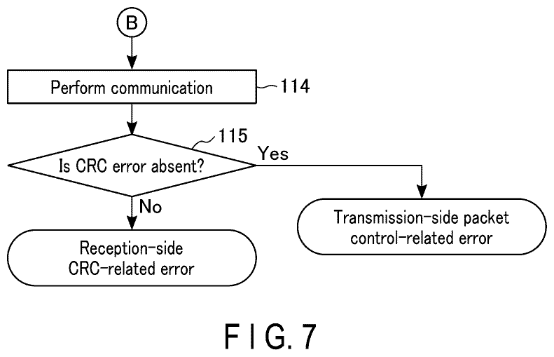

As illustrated in FIG. 7, next, the transmission apparatus 10 performs communication of the reference 8B10B data D4 with the packet structure stored in the data storage medium 14 (S114). The CRC circuit 26 performs CRC of the reception data and checks the presence or absence of a bit error.

In a case where the CRC error is absent (S115_Yes), there is a high possibility that an error related to packet control has occurred in the packet control circuit 12 on the transmission apparatus 10 side.

In a case where the CRC error is not absent (S115_No), there is a high possibility that an error related to CRC has occurred in the CRC circuit 26 on the reception apparatus 20 side.

As described above, the communication apparatus 1 having the configuration according to the present embodiment can check the quality of the communication path.

For example, in a case where a reception error has occurred in the communication apparatus, various causes are conceivable, such as the quality of the transmission path (a cable, contact of a connector, a substrate, or the like), the power supply (external noise, voltage drop, or the like), the communication restriction (interval of packets, disturbance in timing of the control signal in the packet control, disturbance in the packet structure), the system, or the like. At the time of debugging, identification of these causes is required.

Meanwhile, in the configuration according to the present embodiment, the transmission apparatus 10 includes the data storage medium 14 that stores the reference 8B10B data D4 with the packet structure, the reference 8B10B data D5 without the packet structure and including the start code, and the multiplexers 16 and 17. At the time of debugging, the transmission apparatus 10 can switch the data to be transmitted to the reception apparatus 20 side to the 8B10B data D3 with the packet structure, the reference 8B10B data D4 with the packet structure, or the reference 8B10B data D5 without the packet structure. Further, the reception apparatus 20 includes the switch circuit SW1 that switches the presence or absence of the output of the decoding error signal from the 10B8B decoder 24 and the switch circuit SW2 that switches the coupling between the 10B8B decoder 24 and the logic circuit 25. As a result, at the time of debugging, by switching the communication setting, it is possible to identify whether the cause of the reception error is likely to be the 8B10B encoder 13, the disturbance from the downstream-side circuit from the 10B8B decoder 24, the transmission path related or the power source related, the packet control circuit 12, or the CRC circuit 26. As a result, the quality of the communication path in the communication apparatus 1 can be checked.

### 1.5 Modification of First Embodiment

Next, a modification of the first embodiment will be described. In the present modification, a case where a clock generation circuit is provided on the reception apparatus side will be described. Hereinafter, differences from the first embodiment will be mainly described.

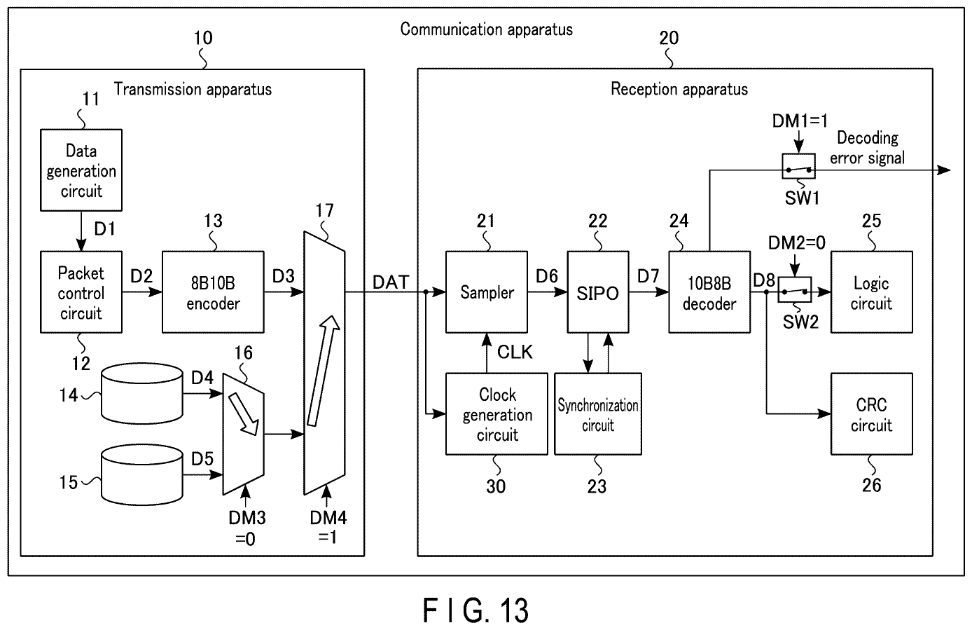

An example of a configuration of the communication apparatus 1 will be described with reference to FIG. 13. FIG. 13 is a block diagram illustrating an example of an overall configuration of the communication apparatus 1.

As illustrated in FIG. 1, the transmission apparatus 10 includes a data generation circuit 11, a packet control circuit 12, an 8B10B encoder 13, data storage media 14 and 15, and multiplexers 16 and 17. The configuration of each circuit is similar to that of the first embodiment.

The reception apparatus 20 includes a sampler 21, a serial-in parallel-out (SIPO) conversion circuit 22, a synchronization circuit 23, a 10B8B decoder 24, a logic circuit 25, a CRC circuit 26, switch circuits SW1 and SW2, and a clock generation circuit 30.

The configurations of the sampler 21, the serial-in parallel-out (SIPO) conversion circuit 22, the synchronization circuit 23, the 10B8B decoder 24, the logic circuit 25, the CRC circuit 26, and the switch circuits SW1 and SW2 are similar to those of the first embodiment.

The clock generation circuit 30 generates (regenerates) the clock signal CLK based on data received from the transmission apparatus 10. For example, since the 8B10B data is toggled at a high frequency, the clock generation circuit 30 can generate (regenerate) the clock signal CLK based on the toggling. The clock generation circuit 30 transmits the clock signal CLK to the sampler 21.

With the configuration according to the present modification, effects similar to those of the first embodiment can be obtained.

Furthermore, with the configuration according to the present modification, a signal line used for transmission of the clock signal CLK between the transmission apparatus 10 and the reception apparatus 20 can be omitted.

### 2. Second Embodiment

Next, a second embodiment will be described. In the second embodiment, a configuration of a communication apparatus 1 and a debugging method (inspection method) different from those of the first embodiment will be described. In the following description, differences from the first embodiment will be mainly described.

### 2.1 Configuration

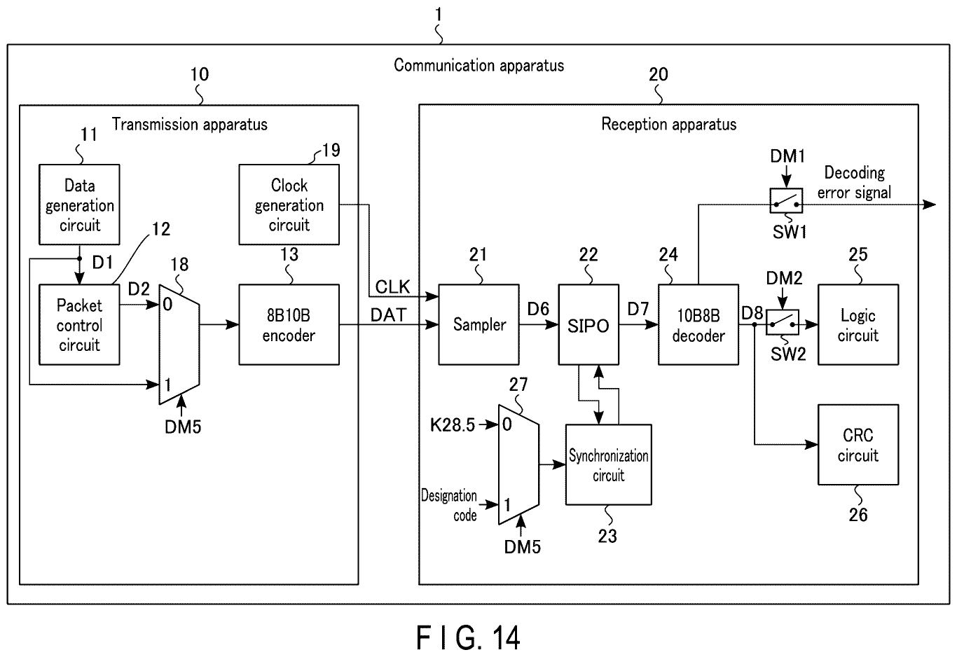

First, an example of the configuration of the communication apparatus 1 will be described with reference to FIG. 14. FIG. 14 is a block diagram illustrating an example of an overall configuration of the communication apparatus 1.

As illustrated in FIG. 14, a transmission apparatus 10 includes a data generation circuit 11, a packet control circuit 12, an 8B10B encoder 13, a multiplexer 18, and a clock generation circuit 19.

The data generation circuit 11 of the present embodiment is coupled to the packet control circuit 12 and a second input terminal of the multiplexer 18. The data generation circuit 11 transmits data D1 to the packet control circuit 12 and the multiplexer 18.

The packet control circuit 12 of the present embodiment is coupled to a first input terminal of the multiplexer 18. The packet control circuit 12 transmits data D2 with an 8-bit width packet structure to the multiplexer 18.

The multiplexer 18 includes the first input terminal, the second input terminal, and an output terminal. The first input terminal is coupled to the packet control circuit 12, and the second input terminal is coupled to the data generation circuit 11. The output terminal is coupled to the 8B10B encoder 13. A debug mode signal DM5 is input to the multiplexer 18. For example, in a case where the debug mode signal DM5 is “0” data, the first input terminal and the output terminal are coupled, and in a case where the debug mode signal DM5 is “1” data, the second input terminal and the output terminal are coupled. That is, in a case where the debug mode signal DM5 is “0” data, the multiplexer 18 can transmit the data D2 to the 8B10B encoder 13. Further, in a case where the debug mode signal DM5 is “1” data, the multiplexer 18 can transmit the data D1 (unpacket-controlled data, that is, 8-bit width data without the packet structure) to the 8B10B encoder 13.

The 8B10B encoder 13 of the present embodiment is coupled to a sampler 21 of a reception apparatus 20 via a transmission path (communication path). The 8B10B encoder 13 may transmit serial data DAT to the sampler 21. More specifically, in a case where the debug mode signal DM5 is “0” data, the 8B10B encoder 13 transmits 8B10B data with the packet structure to the sampler 21. On the other hand, in a case where the debug mode signal DM5 is “1” data, the 8B10B encoder 13 transmits 8B10B data without the packet structure to the sampler 21.

The reception apparatus 20 includes the sampler 21, a SIPO 22, a synchronization circuit 23, a 10B8B decoder 24, a logic circuit 25, a CRC circuit 26, a multiplexer 27, and switch circuits SW1 and SW2.

Configurations of the sampler 21, the SIPO 22, the 10B8B decoder 24, the logic circuit 25, the CRC circuit 26, and the switch circuits SW1 and SW2 are similar to those of the first embodiment.

The multiplexer 27 includes a first input terminal, a second input terminal, and an output terminal. A K28.5 code is input to the first input terminal. An alignment designation code other than K28.5 used for alignment of 10-bit parallel data in the synchronization circuit 23 is input to the second input terminal. The alignment designation code is used in a case where transmission data has no packet structure, that is, does not include the K28.5 code. As the alignment designation code, a 10-bit code that is reliably transmitted by the transmission apparatus 10 is designated. For example, the alignment designation code may be a part of a pseudo-random data string included in the data generation circuit 11. The output terminal is coupled to the synchronization circuit 23. The debug mode signal DM5 is input to the multiplexer 27. For example, in a case where the debug mode signal DM5 is “0” data, the first input terminal and the output terminal are coupled, and in a case where the debug mode signal DM5 is “1” data, the second input terminal and the output terminal are coupled. That is, in the case where the debug mode signal DM5 is “0” data, the multiplexer 27 transmits the K28.5 code to the synchronization circuit 23. Further, in a case where the debug mode signal DM5 is “1” data, the multiplexer 27 can transmit the alignment designation code other than the K28.5 code to the synchronization circuit 23.

The synchronization circuit 23 of the present embodiment aligns parallel data D7 based on the code received from the multiplexer 27. That is, in the case where the debug mode signal DM5 is “0” data, alignment based on the K28.5 code is executed. On the other hand, in the case where the debug mode signal DM5 is “1” data, alignment based on an arbitrary alignment designation code is executed.

### 2.2 Debugging Method

Next, a debugging method (inspection method) for the communication apparatus 1 will be described.

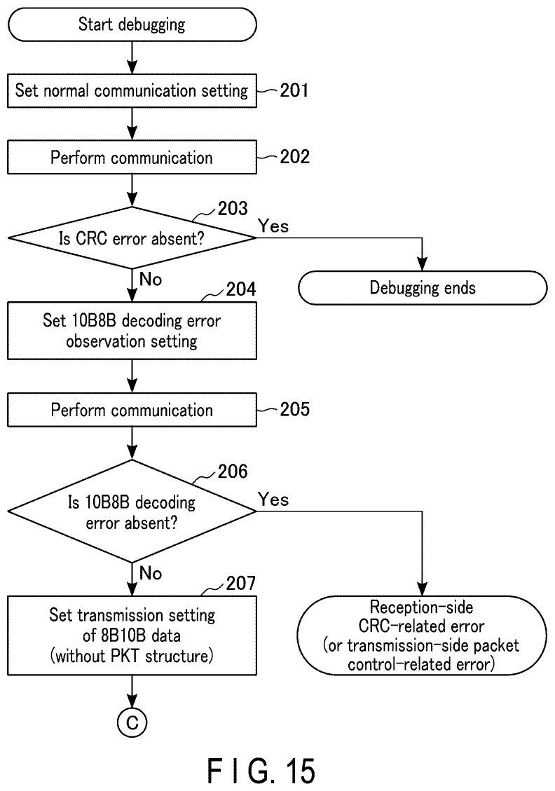

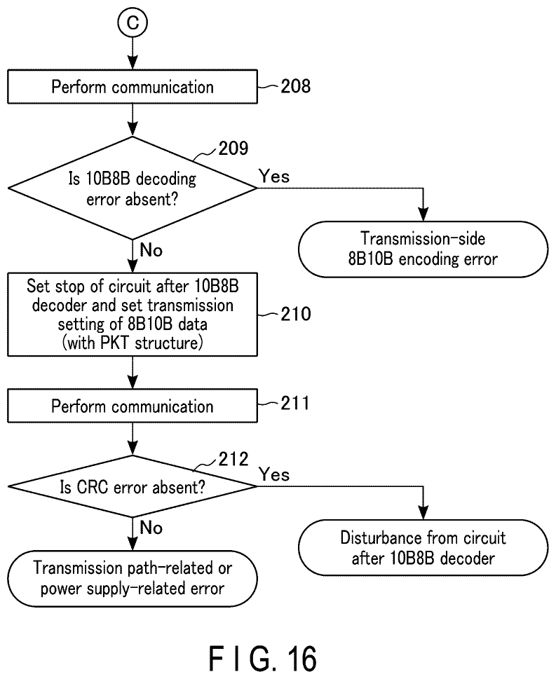

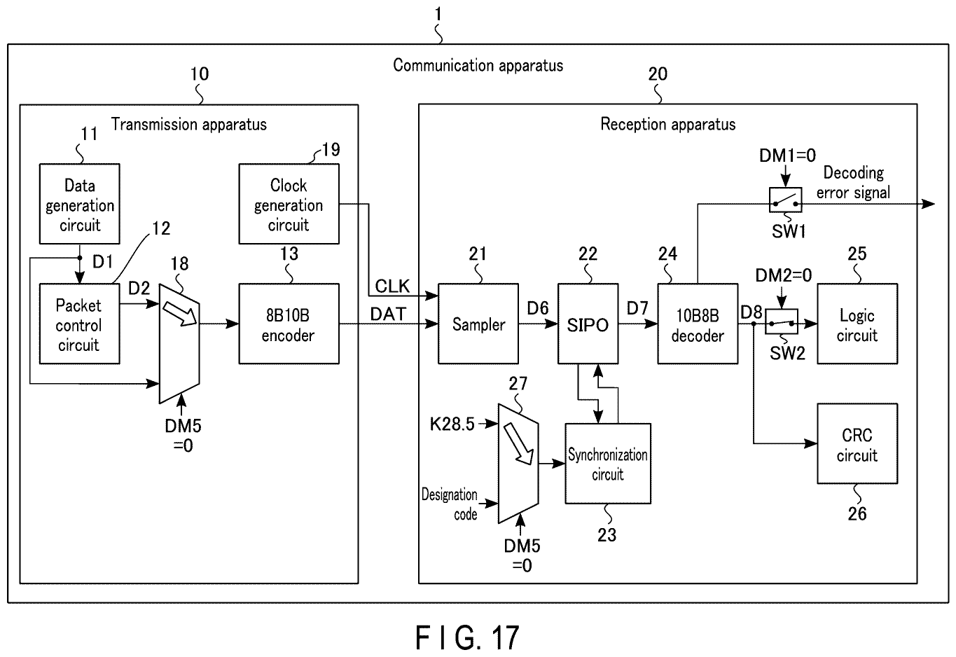

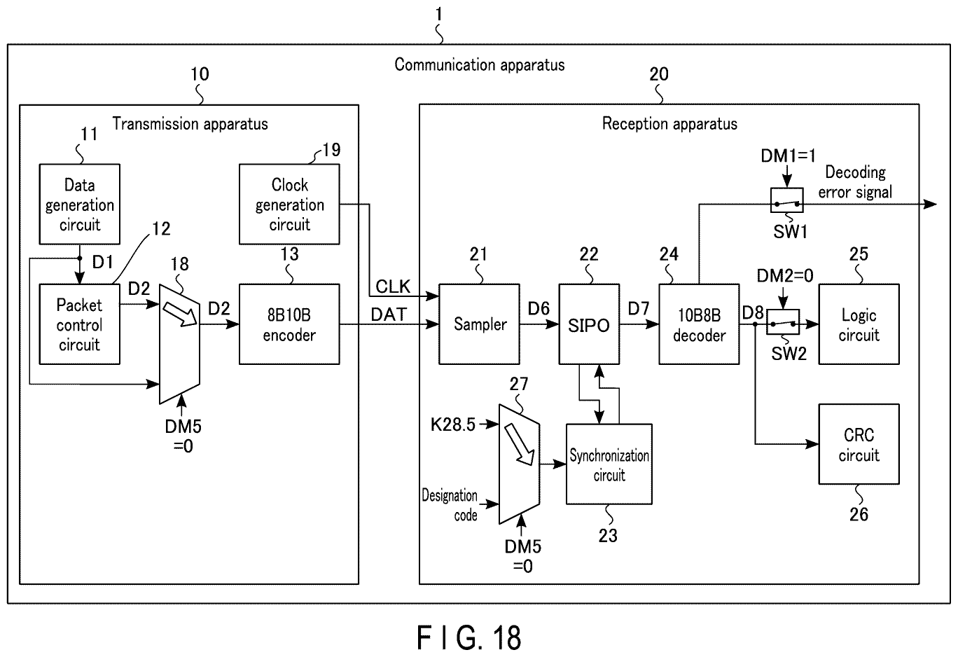

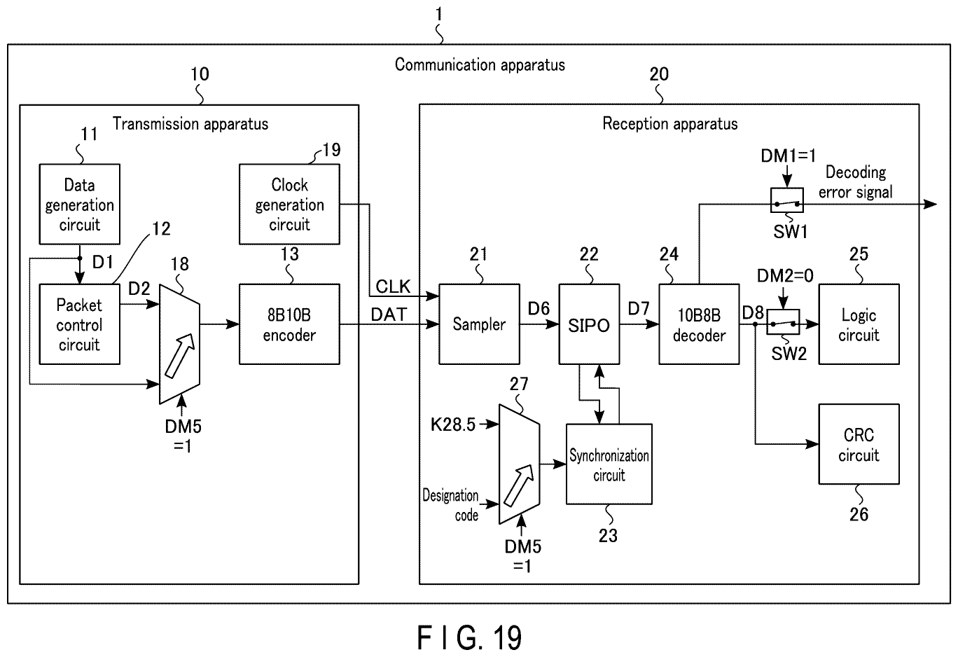

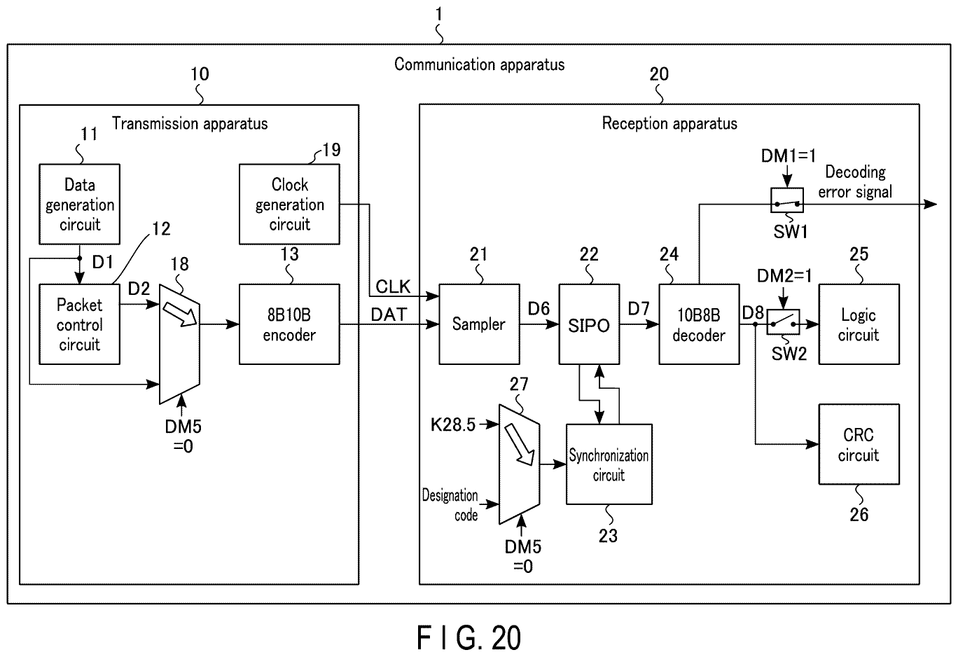

FIGS. 15 and 16 are diagrams illustrating flowcharts of the debugging method. FIG. 17 is a block diagram of the communication apparatus 1 illustrating a state of normal communication setting. FIG. 18 is a block diagram of the communication apparatus 1 illustrating a state of 10B8B decoding error observation setting. FIG. 19 is a block diagram of the communication apparatus 1, illustrating a state of transmission setting of the 8B10B data without the packet structure. FIG. 20 is a block diagram of the communication apparatus 1, illustrating a state of transmission setting of the 8B10B data with the packet structure in a stop state of a circuit after the 10B8B decoder 24.

As illustrated in FIG. 15, first, the communication apparatus 1 is set to the normal communication setting (S201). As illustrated in FIG. 17, debug mode signals DM1, DM2, and DM5 are set to “0”. In the transmission apparatus 10, the multiplexer 18 electrically couples the first input terminal and the output terminal. Accordingly, the packet control circuit 12 can transmit the data D2 with the packet structure to the 8B10B encoder 13. The 8B10B encoder 13 can transmit the 8B10B data with the packet structure as the serial data DAT to the reception apparatus 20 (sampler 21). In the reception apparatus 20, the multiplexer 27 electrically couples the first input terminal and the output terminal. As a result, the synchronization circuit 23 performs alignment of the parallel data D7 based on the K28.5 code. The switch circuit SW1 is turned off. As a result, the decoding error signal output from the 10B8B decoder 24 is not output to the outside. In addition, the switch circuit SW2 is turned on. As a result, the 10B8B decoder 24 can transmit the data D8 to the logic circuit 25.

As illustrated in FIG. 15, next, the transmission apparatus 10 performs communication of the 8B10B data with the packet structure (S202). The CRC circuit 26 performs CRC of the reception data and checks the presence or absence of a bit error.

In a case where the CRC error is absent (S203_Yes), debugging of the communication apparatus 1 is terminated.

In a case where the CRC error is not absent (S203_No), the communication apparatus 1 is set to the 10B8B decoding error observation setting (S204). As illustrated in FIG. 18, the debug mode signal DM1 is set to “1”, and the debug mode signals DM2 and DM5 are set to “0”. In the transmission apparatus 10, the multiplexer 18 electrically couples the first input terminal and the output terminal. Accordingly, the packet control circuit 12 can transmit the data D2 with the packet structure to the 8B10B encoder 13. The 8B10B encoder 13 can transmit the 8B10B data with the packet structure as the serial data DAT to the reception apparatus 20 (sampler 21). In the reception apparatus 20, the multiplexer 27 electrically couples the first input terminal and the output terminal. As a result, the synchronization circuit 23 performs alignment of the parallel data D7 based on the K28.5 code. The switch circuit SW1 is turned on. As a result, the decoding error signal output from the 10B8B decoder 24 is output to the outside. In addition, the switch circuit SW2 is turned on. As a result, the 10B8B decoder 24 can transmit the data D8 to the logic circuit 25.

As illustrated in FIG. 15, next, the transmission apparatus 10 performs communication of the 8B10B data with the packet structure (S205). The presence or absence of a 10B8B decoding error is checked by observing the decoding error signal output from the 10B8B decoder 24.

In a case where the 10B8B decoding error is absent (S206_Yes), in the communication apparatus 1, there is a high possibility that an error related to CRC occurs in the CRC circuit 26 on the reception apparatus 20 side, or an error related to packet control occurs in the packet control circuit 12 on the transmission apparatus 10 side.

In a case where the 10B8B decoding error is not absent (S206_No), the communication apparatus 1 is set to transmission setting of the 8B10B data without the packet structure (S207). As illustrated in FIG. 19, the debug mode signals DM1 and DM5 are set to “1”, and the debug mode signal DM2 is set to “0”. In the transmission apparatus 10, the multiplexer 18 electrically couples the second input terminal and the output terminal. As a result, the data generation circuit 11 can transmit the data D1 without the packet structure to the 8B10B encoder 13. The 8B10B encoder 13 can transmit the 8B10B data without the packet structure as the serial data DAT to the reception apparatus 20 (sampler 21). In the reception apparatus 20, the multiplexer 27 electrically couples the second input terminal and the output terminal. As a result, the synchronization circuit 23 performs alignment of the parallel data D7 based on an arbitrary alignment designation code. The switch circuit SW1 is turned on. As a result, the decoding error signal output from the 10B8B decoder 24 can be output to the outside. In addition, the switch circuit SW2 is turned on. As a result, the 10B8B decoder 24 can transmit the data D8 to the logic circuit 25.

As illustrated in FIG. 16, next, the transmission apparatus 10 performs communication of the 8B10B data without the packet structure (S208). The presence or absence of the 10B8B decoding error is checked by observing the decoding error signal output from the 10B8B decoder 24.

In a case where the 10B8B decoding error is absent (S209_Yes), there is a high possibility that an error has occurred in the 8B10B encoder 13 on the transmission apparatus 10 side in the communication apparatus 1.

In a case where the 10B8B decoding error is not absent (S209_No), the communication apparatus 1 is set to transmission setting of the 8B10B data with the packet structure in the stop state of the circuit after the 10B8B decoder 24 (S210). As illustrated in FIG. 20, the debug mode signals DM1 and DM2 are set to “1”, and the debug mode signal DM5 is set to “0”. In the transmission apparatus 10, the multiplexer 18 electrically couples the first input terminal and the output terminal. Accordingly, the packet control circuit 12 can transmit the data D2 with the packet structure to the 8B10B encoder 13. The 8B10B encoder 13 can transmit the 8B10B data with the packet structure as the serial data DAT to the reception apparatus 20 (sampler 21). The multiplexer 27 electrically couples the first input terminal and the output terminal. As a result, the synchronization circuit 23 performs alignment of the parallel data D7 based on the K28.5 code. The switch circuit SW1 is turned on. As a result, the decoding error signal output from the 10B8B decoder 24 can be output to the outside. In addition, the switch circuit SW2 is turned off. As a result, the 10B8B decoder 24 does not transmit the data D8 to the logic circuit 25.

As illustrated in FIG. 16, next, the transmission apparatus 10 performs communication of the 8B10B data with the packet structure (S211). The CRC circuit 26 performs CRC of the reception data and checks the presence or absence of a bit error.

In a case where the CRC error is absent (S212_Yes), there is a high possibility that an error has occurred due to disturbance from the downstream-side circuit from the 10B8B decoder 24.

In a case where the CRC error is not absent (S212_No), there is a high possibility that an error has occurred related to the transmission path or a power supply.

With the configuration according to the present embodiment, the communication apparatus 1 can obtain effects similar to those of the first embodiment.

The present embodiment and the modification of the first embodiment may be combined. That is, the clock generation circuit 19 in the transmission apparatus 10 may be omitted, and the clock generation circuit 30 may be provided in the reception apparatus 20.

### 3. Third Embodiment

Next, a third embodiment will be described. In the third embodiment, a configuration of a reception apparatus 20 different from that of the first embodiment will be described. Hereinafter, differences from the first and second embodiments will be mainly described.

### 3.1 Configuration

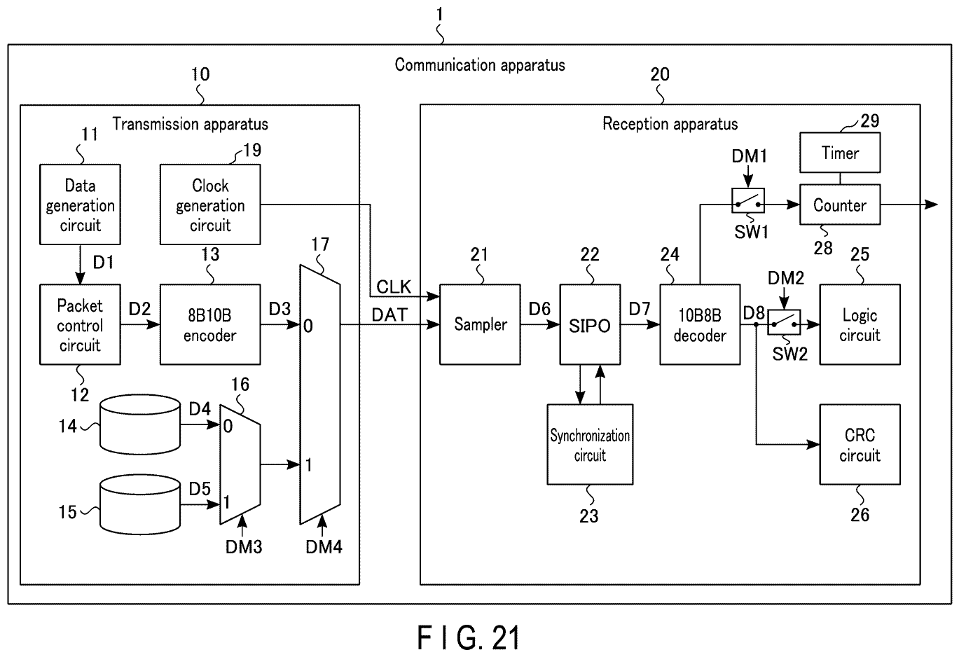

An example of a configuration of a communication apparatus 1 will be described with reference to FIG. 21. FIG. 21 is a block diagram illustrating an example of an overall configuration of the communication apparatus 1.

As illustrated in FIG. 21, the communication apparatus 1 includes a transmission apparatus 10 and a reception apparatus 20. The transmission apparatus 10 and the reception apparatus 20 are coupled via a transmission path.

The configuration of the transmission apparatus 10 is similar to the configuration described with reference to FIG. 1 of the first embodiment.

The reception apparatus 20 includes a sampler 21, a serial-in parallel-out (SIPO) conversion circuit 22, a synchronization circuit 23, a 10B8B decoder 24, a logic circuit 25, a CRC circuit 26, a counter 28, a timer 29, and switch circuits SW1 and SW2. Note that the counter 28 and the timer 29 may be provided outside the reception apparatus 20.

Configurations of the sampler 21, the SIPO 22, the synchronization circuit 23, the 10B8B decoder 24, the logic circuit 25, the CRC circuit 26, and the switch circuit SW2 are similar to those of the first embodiment.

The switch circuit SW1 switches coupling between the 10B8B decoder 24 and the outside. One end of the switch circuit SW1 is coupled to the 10B8B decoder 24, and the other end of the switch circuit SW1 is coupled to the counter 28. A debug mode signal DM1 is input to the switch circuit SW1 as a control signal. For example, in a case where the debug mode signal DM1 is “0” data, the switch circuit SW1 is turned off. On the other hand, in a case where the debug mode signal DM1 is “1” data, the switch circuit SW1 is turned on.

The counter 28 counts the number of 10B8B decoding errors. The counter 28 outputs a count number to the outside. The counter 28 is coupled to the timer 29. For example, the counter 28 counts the number of decoding errors that have occurred in an arbitrary period based on control of the timer 29. For example, at the time of debugging, an error occurrence frequency can be checked by counting the number of 10B8B decoding errors. The quality of communication can be checked by the error occurrence frequency.

The timer 29 controls the counter 28.

With the configuration according to the present embodiment, effects similar to those of the first embodiment can be obtained.

Furthermore, with the configuration according to the present embodiment, the number of 10B8B decoding errors that have occurred in the arbitrary period can be counted at the time of debugging. As a result, the quality of communication (the error occurrence frequency) can be checked.

Note that the second embodiment and the third embodiment may be combined. That is, the counter 28 and the timer 29 may be added to the second embodiment.

Further, the present embodiment and the modification of the first embodiment may be combined. That is, the clock generation circuit 19 in the transmission apparatus 10 may be omitted, and the clock generation circuit 30 may be provided in the reception apparatus 20.

### 4. Modification and the Like

The communication apparatus according to the above embodiments includes a transmission apparatus (10) configured to output serial data based on an 8B10B method, and a reception apparatus (20) coupled to the transmission apparatus via a transmission path and configured to receive the serial data from the transmission apparatus. The transmission apparatus includes a data generation circuit (11) configured to generate first data (D1), a packet control circuit (12) coupled to the data generation circuit and configured to generate second data (D2) having a packet structure based on the first data, an encoder (13) coupled to the packet control circuit and configured to generate third data (D3) by encoding the second data into a code having a 10-bit width of the 8B10B method, a first storage medium (14) configured to store first reference data (D4) having the packet structure, the first reference data being encoded based on the 8B10B method, a second storage medium (15) configured to store second reference data (D5) not having the packet structure and including a packet start code, the second reference data being encoded based on the 8B10B method, a first multiplexer (16) including a first input terminal coupled to the first storage medium, a second input terminal coupled to the second storage medium, and a first output terminal, a second multiplexer (17) including a third input terminal coupled to the encoder, a fourth input terminal coupled to the first output terminal of the first multiplexer, and a second output terminal coupled to the reception apparatus. The reception apparatus includes a conversion circuit (22) configured to convert the serial data (D6) into parallel data (D7), a synchronization circuit (23) coupled to the conversion circuit and configured to perform alignment of the parallel data, a decoder (24) coupled to the conversion circuit and configured to decode the parallel data to generate fourth data (D8) having an 8-bit width of the 8B10B method, and an inspection circuit (26) coupled to the decoder and configured to detect a bit error based on the fourth data.

According to the above embodiments, the communication apparatus can check the quality of the communication path with the configuration.

Note that the present invention is not limited to the above-described embodiments, and various modifications can be applied.

The “coupling” in the above embodiments also includes a state of being indirectly coupled with, for example, a transistor or a resistor interposed therebetween.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus comprising:
a transmission apparatus configured to output serial data based on an 8B10B method; and
a reception apparatus coupled to the transmission apparatus via a transmission path and configured to receive the serial data from the transmission apparatus, wherein
the transmission apparatus includes:
a data generation circuit configured to generate first data;
a packet control circuit coupled to the data generation circuit and configured to generate second data having a packet structure based on the first data;
an encoder coupled to the packet control circuit and configured to generate third data by encoding the second data into a code having a 10-bit width of the 8B10B method;
a first storage medium configured to store first reference data having the packet structure, the first reference data being encoded based on the 8B10B method;
a second storage medium configured to store second reference data not having the packet structure and including a packet start code, the second reference data being encoded based on the 8B10B method;
a first multiplexer including a first input terminal coupled to the first storage medium, a second input terminal coupled to the second storage medium, and a first output terminal; and
a second multiplexer including a third input terminal coupled to the encoder, a fourth input terminal coupled to the first output terminal of the first multiplexer, and a second output terminal coupled to the reception apparatus, and
the reception apparatus includes:
a conversion circuit configured to convert the serial data into parallel data;
a synchronization circuit coupled to the conversion circuit and configured to perform alignment of the parallel data;
a decoder coupled to the conversion circuit and configured to decode the parallel data to generate fourth data having an 8-bit width of the 8B10B method; and
an inspection circuit coupled to the decoder and configured to detect a bit error based on the fourth data.

2. The communication apparatus according to claim 1, wherein
each of the third data and the first reference data includes the packet start code and a packet end code, and
the second reference data does not include the packet start code and the packet end code.

3. The communication apparatus according to claim 1, wherein
the first reference data and the second reference data are transmitted to the reception apparatus during debugging.

4. The communication apparatus according to claim 2, wherein
the synchronization circuit is configured to execute alignment in a case where the serial data is converted into the parallel data based on the packet start code.

5. The communication apparatus according to claim 1, wherein
the decoder is further configured to output a decoding error in a case where the parallel data does not conform to a rule of the 8B10B method.

6. The communication apparatus according to claim 5, wherein
the reception apparatus further includes a counter that is configured to count the decoding error.

7. The communication apparatus according to claim 1, wherein
the first data, the second data, and the fourth data have the 8-bit width, and
the third data, the first reference data, and the second reference data have the 10-bit width.

8. A communication apparatus comprising:
a transmission apparatus configured to output serial data based on an 8B10B method; and
a reception apparatus coupled to the transmission apparatus via a transmission path and configured to receive the serial data from the transmission apparatus, wherein
the transmission apparatus includes:
a data generation circuit configured to generate first data;
a packet control circuit coupled to the data generation circuit and configured to generate second data having a packet structure based on the first data;
a third multiplexer including a fifth input terminal coupled to the packet control circuit, a sixth input terminal coupled to the data generation circuit, and a third output terminal; and
an encoder coupled to the third output terminal of the third multiplexer and the reception apparatus and configured to transmit the serial data generated by encoding one of the first data and the second data into a code having a 10-bit width of the 8B10B method to the reception apparatus, and
the reception apparatus includes:
a conversion circuit configured to convert the serial data into parallel data;
a fourth multiplexer including a seventh input terminal to which a packet start code is input, an eighth input terminal to which an alignment designation code is input, and a fourth output terminal;
a synchronization circuit coupled to the conversion circuit and the fourth output terminal of the fourth multiplexer and configured to perform alignment of the parallel data using one of the packet start code and the alignment designation code;
a decoder coupled to the conversion circuit and configured to decode the parallel data to generate fourth data having an 8-bit width of the 8B10B method; and
an inspection circuit coupled to the decoder and configured to detect a bit error based on the fourth data.

9. The communication apparatus according to claim 8, wherein
the encoder is configured to generate the serial data not including the packet start code and a packet end code in a case of encoding the first data, and generate the serial data including the packet start code and the packet end code in a case of encoding the second data.

10. The communication apparatus according to claim 9, wherein
the serial data not including the packet start code and the packet end code is transmitted to the reception apparatus at a time of inspection.

11. The communication apparatus according to claim 8, wherein
a same control signal is input to the third multiplexer and the fourth multiplexer,
in a case where the fifth input terminal and the third output terminal are coupled in the third multiplexer, the seventh input terminal and the fourth output terminal are coupled in the fourth multiplexer, and
in a case where the sixth input terminal and the third output terminal are coupled in the third multiplexer, the eighth input terminal and the fourth output terminal are coupled in the fourth multiplexer.

12. An inspection method for a communication apparatus including a transmission apparatus configured to output serial data based on an 8B10B method and a reception apparatus configured to receive the serial data from the transmission apparatus, the inspection method comprising:
transmitting, from the transmission apparatus to the reception apparatus, first data having the packet structure encoded in a 10-bit width code in the transmission apparatus as the serial data;
checking presence or absence of a bit error in second data having an 8-bit width generated by decoding first parallel data based on the first data in the reception apparatus;
checking presence or absence of a decoding error of the second data in a case where the bit error is present;
transmitting, from the transmission apparatus to the reception apparatus, third data not having the packet structure of the 10-bit width as the serial data in a case where the decoding error is present in the second data; and
checking presence or absence of the decoding error of fourth data having the 8-bit width generated by decoding second parallel data based on the third data.

13. The inspection method for the communication apparatus according to claim 12, further comprising:
transmitting, from the transmission apparatus to the reception apparatus, fifth data having the packet structure of the 10-bit width as the serial data in a case where the decoding error is absent in the second data; and
checking presence or absence of the bit error of sixth data having the 8-bit width generated by decoding third parallel data based on the fifth data.

14. The inspection method for the communication apparatus according to claim 13, wherein
the reception apparatus includes:
a decoder configured to decode the first parallel data, the second parallel data, and the third parallel data; and
a logic circuit coupled to the decoder via a switch circuit and configured to receive decoded data from the decoder, and
the inspection method is further comprising:
turning off the switch circuit and checking presence or absence of the bit error of the sixth data in a case where the decoding error is present in the third data.

15. The inspection method for the communication apparatus according to claim 12, wherein
the reception apparatus includes:
a decoder configured to decode the first parallel data and the second parallel data; and
a logic circuit coupled to the decoder via a switch circuit and receives decoded data from the decoder, and
the inspection method is further comprising:
turning off the switch circuit and checking presence or absence of the bit error of the second data in a case where the decoding error is present in the third data.

16. The inspection method for the communication apparatus according to claim 12, wherein
the presence or absence of the bit error is based on a cyclic redundancy check (CRC).

17. The inspection method for the communication apparatus according to claim 13, wherein
the transmission apparatus includes:
a data generation circuit configured to generate seventh data;
a packet control circuit coupled to the data generation circuit and configured to generate eighth data having the packet structure based on the seventh data;
an encoder coupled to the packet control circuit and configured to encode the eighth data to generate the first data;
a first storage medium configured to store the third data; and
a second storage medium configured to store the fifth data.

18. The inspection method for the communication apparatus according to claim 12, wherein
the transmission apparatus includes:
a data generation circuit configured to generate seventh data;
a packet control circuit coupled to the data generation circuit and configured to generate eighth data having the packet structure based on the seventh data; and
an encoder configured to encode the seventh data to generate the first data in a case where the seventh data is received, and encode the eighth data to generate the third data in a case where the eighth data is received.
